(19) United States
(12) Patent Application Publication
(10) Pub. No.: US 2016/0075905 A1
(43) Pub. Date: Mar. 17, 2016

(54) POLYMERIC COMPOSITIONS WITH IMPROVED NOISE SUPPRESSION

(71) Applicant: Eastman Chemical Company, Kingsport, TN (US)

(72) Inventors: Michael Dean Funderburg, Gray, TN (US); Joseph Alexander DeLoach, Jonesborough, TN (US); Jesus Gabriel Moralez, Kingsport, TN (US)

(73) Assignee: EASTMAN CHEMICAL COMPANY, Kingsport, TN (US)

(21) Appl. No.: 14/852,677

(22) Filed: Sep. 14, 2015

Related U.S. Application Data
(60) Provisional application No. 62/050,951, filed on Sep. 16, 2014.

(51) Int. Cl. C09D 127/06; B05D 3/02; B29C 65/48; B05D 1/02

(52) U.S. Cl. CPC C09D 127/06; B05D 1/02; B05D 3/0254; B29C 65/48; B29L 2031/3005

(57) ABSTRACT

Disclosed is a method for improving vibration damping of a substrate, such as the underbody of an automobile. The method comprises applying a plastisol which comprises a polymeric component and a polymeric plasticizer. The fused plastisol has improved damping behavior as determined using Dynamic Mechanical Thermal Analysis. Novel plastisols are also disclosed.

### CROSS-REFERENCE TO RELATED APPLICATION

This application claims priority to U.S. Provisional Application No. 62/050,951 filed Sep. 16, 2014, the disclosure of which is incorporated herein by reference in its entirety.

### FIELD OF THE INVENTION

The invention relates to improving vibration damping on a substrate. More specifically, the invention relates to the use of plastisols to improve vibration damping on a substrate, such as the underbody of a vehicle. The invention also relates to novel plastisols and plasticizers for improving vibration damping.

### BACKGROUND OF THE INVENTION

The objective of this invention is to provide improved vibration damping performance to metallic substrates. Examples of such substrates include, but are not limited to, those used for the construction of vehicles. More specifically, the objective of this invention is to provide improved vibration damping within the range of temperatures frequently encountered during driving, namely from −30° to 50° C. and most frequently from −10° C. to 40° C. Another objective of this invention is to provide improved vibration damping within this temperature range across the frequencies audible to humans, particularly in the low frequency range of 10 to 200 Hz as described in “Low Frequency Noise. What we know, what we do not know, and what we would like to know”, Leventhall, Geoff, Journal of Low Frequency Noise, Vibration and Active Control 28, 2, pp. 79-104 (2009).

The reduction of noise, vibration, and harshness (often abbreviated as NVH) to humans is a goal of many industrial processes. Exposure to NVH comes from numerous sources, and can be mitigated by various means. For example, laminated safety glass can be comprised of acoustic interlayers which suppress sound transmission. Applications of such acoustic interlayers can include glass panes in commercial and residential buildings and automotive glazing. Other sources of NVH in vehicles include engine noise, road noise, springs and suspensions, braking, and chassis vibration. Noise suppression techniques include component design to reduce vibration and sound transmission; use of composite materials instead of metals; elastomeric sleeves or guards; nonwoven fabrics; carpet or other materials applied to the vehicle interior; foam; liquid-applied damping formulations; and objects produced from viscoelastic materials, such as bitumen or asphaltic pads. Although effective to varying extents depending on the source of the noise, these techniques suffer from limitations. For example, asphaltic pads cannot easily be placed and conformed to some locations on a vehicle body, require manual application, are subject to embrittlement, and must continue to adhere to the metal substrate in order to be effective. Some materials contribute undesired weight to the vehicle, contrary to weight reduction goals designed to improve fuel mileage. Materials which require high temperature and/or long times to cure can slow production, add cost, and result in higher energy usage.

One mode of NVH is through vibration. Polymeric materials can damp, or reduce oscillations of, a substrate by dissipating the oscillation energy with their viscoelastic behavior. A standard measurement of damping utilizes the Oberst method and apparatus. In this method, a material engineered to confer damping behavior is affixed to a stainless steel bar which has negligible damping itself. The effect of the damping material is deduced from the behavior of the sample bar compared to an untreated reference bar. Damping behavior may also be measured using Dynamic Mechanical Thermal Analysis, or DMTA. In this technique, a sample is exposed to a sinusoidal force, generally over a range of temperatures or frequencies. When heated, the modulus of a viscoelastic polymeric substance varies greatly from the glassy state at low temperatures, through the glass transition to a rubbery state, and finally to a lower viscosity molten state. The ratio of the storage modulus to the loss modulus, a value known as the tan δ, is a measure of the material's ability to damp vibrations. Higher tan δ values signify more effective damping behavior. The DMTA tan δ has been shown to correlate well with the Oberst bar testing.

Plasticized polyvinyl chloride (PVC) is well known in the automotive industry. Plasticized PVC applied as a plastisol in automotive underbody coatings and sealants, after thermal curing, can protect the vehicle from chipping by stones and other materials on the road surface. Such coatings also offer protection against corrosion, for example from salted roads. Plasticized PVC coatings can also provide a low level of reduction of the transmission of vibrations from metallic substrates. However, the performance of plasticized PVC coatings is inadequate to confer satisfactory vibration damping across the range of temperatures and noise frequencies typically encountered without the incorporation of additional damping techniques. These performance deficiencies are exacerbated when the desire to reduce NVH to vehicle passengers over traditional levels is considered. Despite these deficiencies, the ease of application and economy of PVC plastisols make them an appealing potential solution to the reduction of NVH should performance improvements be realized.

### SUMMARY OF THE INVENTION

An embodiment of the present invention is a plastisol comprising a polymeric component and a polymeric plasticizer. The polymeric plasticizer is produced by reaction (I)

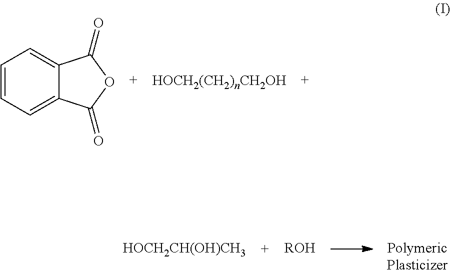 [SMILES: O=C1OC(=O)c2ccccc21 ; "HOCH2CH(OH)CH3" ; "ROH"]

n ranges from 0 to 8. R is selected from the group consisting of saturated, linear or branched alkyl having 1 to 10 carbon atoms. The number average molecular weight of the polymeric plasticizer ranges from 400 to 3 000. The plastisol comprises 10 weight percent to 70 weight percent of the polymeric plasticizer, 10 weight percent to 70 weight percent of the polymeric component, and 10 weight percent to 80 weight percent of other components, each based on the total weight of the plastisol. The other components comprise a second plasticizer, fillers, pigments, stabilizers, foaming agents, hollow materials, elastomeric materials, rheology control additives, and/or adhesion promoters.

Another embodiment is a method of vibration damping comprising affixing a plastisols to a substrate. The plastisol comprises a polymeric component and a polymeric plasticizer. The polymeric plasticizer is produced by reaction (I)

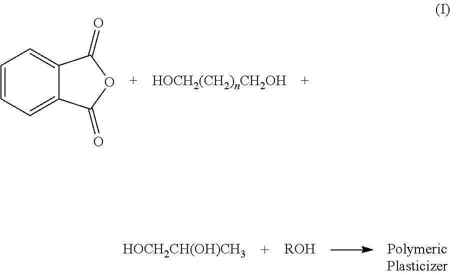 [SMILES: O=C1OC(=O)c2ccccc21 ; "HOCH2CH(OH)CH3" ; "ROH"]

n ranges from 0 to 8. R is selected from the group consisting of saturated, linear or branched alkyl having 1 to 10 carbon atoms. The number average molecular weight of the polymeric plasticizer ranges from 400 to 3,000.

### DETAILED DESCRIPTION OF THE INVENTION

As used herein the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “affixing”, as used herein, refers to providing continuous and intimate contact between the plastisol and the substrate such that the fused plastisol remains on the substrate. For example, a plastisol can be affixed to a car underbody via spray coating the plastisol onto a car underbody and subjecting the coated car underbody to conditions to fuse the plastisol. The term “adhering” as used herein, refers to using an adhesive to affix a fused plastisol sheet to a substrate.

The term “esterification product”, as used herein, refers to the blend of “partial esters”, “mixed esters”, and “like esters” produced from the reaction of one or more carboxylic acids with a polyol. The term “partial esters”, as used herein, refers to the reaction product wherein not all of the hydroxyls of a polyol have fully reacted with a carboxylic acid. The term “mixed ester”, as used herein, refers to the reaction product wherein the hydroxyls of a polyol have reacted with different carboxylic acids. The term “like esters”, as used herein, refers to the reaction product wherein each hydroxyl of a polyol has reacted with the same carboxylic acid. The term “the reaction product of formula (a), formula (b), formula (c), and/or formula (d) with formula (e)”, as used herein, is intended to include the carboxylic acids and the corresponding esters, anhydrides, and/or acid chlorides of formula (a), formula (b), formula (c), and/or formula (d) as explicitly set forth in the claims.

The term “plastisol”, as used herein, refers to a liquid dispersion of polymeric resin particles, optionally with other ingredients, in a plasticizer. The term “fused plastisol”, as used herein, refers to the solid plastic material that is formed upon fusing the plastisol and subsequently cooling to a desired temperature. The term “fusing”, as used herein, refers to heating of the plastisol to a temperature sufficient to yield a solid structure with mechanical integrity.

The term “substrate”, as used herein, refers to the material that provides the surface onto which the plastisol is affixed.

One embodiment of the present invention is a plastisol comprising a polymeric component and a polymeric plasticizer. The polymeric plasticizer is produced by reaction (I)

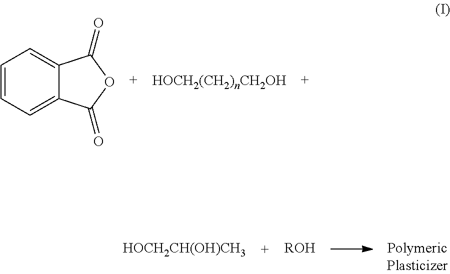 [SMILES: O=C1OC(=O)c2ccccc21 ; "HOCH2CH(OH)CH3" ; "ROH"]

n ranges from 0 to 8. R is selected from the group consisting of saturated, linear or branched alkyl having 1 to 10 carbon atoms. The number average molecular weight of the polymeric plasticizer ranges from 400 to 3 000. The plastisol comprises 10 weight percent to 70 weight percent of the polymeric plasticizer, 10 weight percent to 70 weight percent of the polymeric component, and 10 weight percent to 80 weight percent of other components, each based on the total weight of the plastisol. The other components comprise a second plasticizer, fillers, pigments, stabilizers, foaming agents, hollow materials, elastomeric materials, rheology control additives, and/or adhesion promoters.

In one aspect, n is 2 and R is 2-ethylhexyl. In another aspect, the number average molecular weight of the polymeric plasticizer ranges from 400 to 2,000, or 600 to 1,800.

In addition to the plasticizer, the plastisol comprises a polymeric component. In one aspect, the polymeric component comprises polyvinyl chloride, polyvinyl acetate, acrylic polymers and/or vinyl chloride-containing copolymers. In one aspect, the polymeric component comprises polyvinyl chloride and/or acrylic polymers. In one aspect, the polymeric component comprises polyvinyl chloride and/or polyvinyl acetate. In one aspect, the polymeric component comprises polyvinyl chloride and/or vinyl chloride-containing copolymers comprising vinyl acetate. In one aspect, the polymeric component comprises polyvinyl chloride and vinyl chloride-containing copolymers comprising acrylic. In one aspect, the polymeric component comprises polyvinyl chloride.

The plastisol comprises polymeric plasticizer, polymeric component, and other components. Examples of other components include, but are not limited to, a second plasticizer, fillers, pigments, stabilizers, foaming agents, hollow materials, elastomeric materials, rheology control additives, and adhesion promoters. The amounts of polymeric plasticizer, polymeric component, and other components can vary widely. For example, in one aspect the plastisol comprises 10 weight percent to 70 weight percent polymeric plasticizer, 10 weight percent to 70 weight percent polymeric component, and 10 weight percent to 80 weight percent other components, each based on the total weight of the plastisol. Other examples include, 15 weight percent to 60 weight percent polymeric plasticizer, 15 weight percent to 60 weight percent polymeric component, and 10 weight percent to 60 weight percent other components; or 20 weight percent to 45 weight percent polymeric plasticizer, 20 weight percent to 45 weight percent polymeric component, and 10 weight percent to 50 weight percent other components.

The viscosity of the plastisol can vary over a wide range. In one aspect, the plastisol has a viscosity ranging from 5,000 centipoise (cP) to 200,000 cP using Brookfield viscosity measurement at 23° C. In other examples, the plastisol has a viscosity ranging from 30,000 cP to 120,000 cP or from 40,000 cP to 90,000 cP.

In one aspect, the plastisol comprises a second plasticizer. In one aspect the second plasticizer comprises phthalates; terephthalates; isophthalates; trimellitates; adipates; cyclohexanedicarboxylates; benzoates; phosphates; diesters of ethylene glycol, propylene glycol, their oligomers, and mixtures thereof; citrates; succinates; alkyl sulfonates; fatty acid esters and epoxidized fatty acid esters; triglycerides and epoxidized triglycerides, optionally substituted; dianhydrohexitol diesters; pentaerythritol-based tetraesters; furan-based esters; other esters; ketals; and/or other polymeric plasticizers. In another aspect, the second plasticizer comprises dioctyl terephthalate, diisooctyl phthalate, di-2-ethylhexyl phthalate, di-2-ethylhexyl terephthalate, tri-2-ethylhexyl trimellitate, di-2-propylheptyl phthalate, diisononyl phthalate, diisodecyl phthalate, diisoundecyl phthalate, ditridecyl phthalate, trioctyl trimellitate, triisononyl trimellitate, 2,2,4-trimethyl-1,3-pentanediol diisobutyrate, isononyl benzoate, isodecyl benzoate, diisononyl 1,2-cyclohexanedicarboxylate, dioctyl adipate, di-2-ethylhexyl adipate, triethylene glycol di-2-ethylhexanoate, diethylene glycol dibenzoate, dipropylene glycol dibenzoate, and/or dibenzoates produced from mixtures of diethylene glycol and dipropylene glycol. In one aspect, the second plasticizer comprises dioctyl terephthalate, di-2-ethylhexyl terephthalate, dioctyl adipate, di-2-ethylhexyl adipate, and/or triethylene glycol di-2-ethylhexanoate. In one aspect, the second plasticizer comprises, di-2-ethylhexyl terephthalate, diisononyl phthalate, and/or diisononyl 1,2-cyclohexanedicarboxylate.

In one aspect, the plastisol comprises fillers. Nonlimiting examples of fillers include calcium carbonate, magnesium carbonate, silica, clay, mica, graphite, zinc oxide, and/or calcium oxide. In one aspect, the fillers comprise calcium carbonate.

The plastisol, in one aspect, can comprise stabilizers. Nonlimiting examples of stabilizers include metal soaps, epoxidized oils and epoxidized fatty acid esters, and/or organotin compounds.

In one aspect, the plastisol can be formulated or produced in a manner which incorporates more free volume into the fused plastisol. In one such technique, mechanical frothing can be applied to produce a foamed plastisol. In another aspect, a chemical foaming agent which results in a foamed structure after fusing is completed can be used. One non-limiting example of such a foaming agent is azodicarbonamide. In one aspect, a catalyst is used along with the chemical foaming agent. In another aspect, foam stabilizers are used. In another aspect, hollow materials are incorporated into the plastisol. Nonlimiting examples of hollow materials include glass beads, microbeads, and/or microspheres, which can be produced from either inorganic or polymeric organic substances. In one aspect, the hollow materials are thermoplastic microspheres.

In one aspect, the plastisol comprises elastomeric materials. Nonlimiting examples of elastomeric materials include nitrile-butadiene rubber, natural rubber, isoprene rubber, butadiene rubber, styrene-butadiene rubber, butyl rubber, ethylene-propylene-diene monomer (EPDM) rubber, chloroprene rubber, styrenated block copolymers, ethylene-vinyl acetate copolymers, olefinic elastomers, olefinic copolymer elastomers, silicone elastomers, polysulfide elastomers, and/or polyurethane elastomers.

In another aspect, additives to control rheology can be incorporated into the plastisols. These may include secondary plasticizers or diluents. Examples of such additives include petroleum distillates; hydrocarbon oils such as, for example, mineral oil and mineral spirits; fatty acid esters; polyphenyl oligomers, optionally partially hydrogenated; and organic solvents. Conversely, thickeners may be added to boost viscosity as desired. Materials and techniques for adjusting plastisol rheology are well known in the art.

In one aspect, the plastisol comprises adhesion promoters. Nonlimiting examples of adhesion promoters include polyamidoamines, blocked isocyanates and isocyanurates, silanes, and/or epoxy resins.

In one aspect, the fused plastisol has a maximum Tan Delta (Tan δₘₐₓ) occurring between 10° C. and 50° C. and has Tan Delta at 30° C. (Tan δ_{30C}) ranging from 0.5 to 2.0, when measured on a sample nominally 0.6-0.7 mm thick, 3.2 mm wide, and 10-12 mm long using a Dynamic Mechanical Analyzer with a Tension Clamp at a strain of 0.1% and at a frequency of 1 Hz and a temperature ramp rate of 3° C./min.

In one aspect, Tan Delta at 30° C. (Tan δ_{30C}) ranges from 0.5 to 1.8 or 0.5 to 1.6 or 0.5 to 1.4 or 0.6 to 2.0 or 0.6 to 1.8 or 0.6 to 1.6 or 0.6 to 1.4 or 0.7 to 2.0 or 0.7 to 1.8 or 0.7 to 1.6 or 0.7 to 1.4. In one aspect, Tan Delta at 20° C. (Tan δ_{20C}) ranges from 0.5 to 1.8 or 0.5 to 1.6 or 0.5 to 1.4 or 0.6 to 2.0 or 0.6 to 1.8 or 0.6 to 1.6 or 0.6 to 1.4 or 0.7 to 2.0 or 0.7 to 1.8 or 0.7 to 1.6 or 0.7 to 1.4. In one aspect, the maximum Tan Delta (Tan δₘₐₓ) occurs between 10° C. and 40° C. or 20° C. and 50° C.

Another embodiment of the present invention is a method of improving vibration damping of a substrate comprising affixing a plastisol to a substrate. The plastisol comprises a polymeric component and a polymeric plasticizer. The polymeric plasticizer is produced by reaction (I)

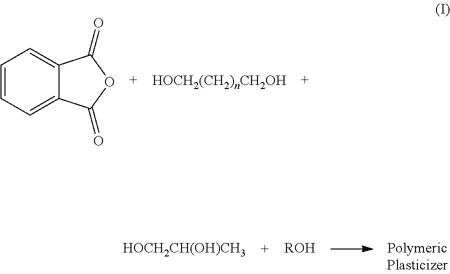 [SMILES: O=C1OC(=O)c2ccccc21 ; "HOCH2CH(OH)CH3" ; "ROH"]

n ranges from 0 to 8. R is selected from the group consisting of saturated, linear or branched alkyl having 1 to 10 carbon atoms. The number average molecular weight of the polymeric plasticizer ranges from 400 to 3,000.

All of the aspects of the plastisol described herein above specific to the plastisol formulation, polymeric component, and other components apply to the plastisol made with the polymeric plasticizer and aspects of polymeric plasticizer apply to the method of improving vibration damping. For example, n and the R group, the polymeric component, the amounts of polymeric plasticizer, polymeric component, and other components in the plastisol, plastisol viscosity ranges, second plasticizers, fillers, stabilizers, foaming agents, hollow materials, elastomeric materials, rheology control additives, adhesion promoters, maximum Tan Delta, Tan Delta at 20° C. and Tan Delta at 30° C. apply to the method of improving vibration damping of a substrate.

The substrate is not particularly limited. In one aspect, the substrate is metal. In one aspect, the substrate comprises steel. In one aspect, the substrate comprises aluminum. In one aspect, the substrate is part of a wheeled vehicle. In another aspect, the substrate is on the underbody of a wheeled vehicle.

In one aspect, the method of affixing the plastisol onto the substrate comprises (a) applying the plastisol onto the substrate, (b) fusing the plastisol to produce a plastisol-covered substrate, and (c) cooling the plastisol-covered substrate to ambient temperatures. The method for applying the plastisol onto the substrate is not particularly limited. In one aspect, applying the plastisol onto the substrate comprises coating the substrate with the plastisol. Nonlimiting examples of coating include spray coating and/or extrusion coating.

In one aspect, the method of affixing the plastisol to the substrate comprises (a) fusing the plastisol into a sheet and (b) adhering the sheet to the substrate.

In one aspect, the fusing occurs at a temperature ranging from 100° C. to 220° C. for a time period ranging from 1 min to 2 hours. In another aspect, the fusing occurs at a temperature ranging from 140° C. to 180° C. for a time period ranging from 15 min. to 40 min.

Listed below are non-limiting embodiments.

A1. A plastisol comprising a polymeric component and a polymeric plasticizer. The polymeric plasticizer is produced by reaction (I)

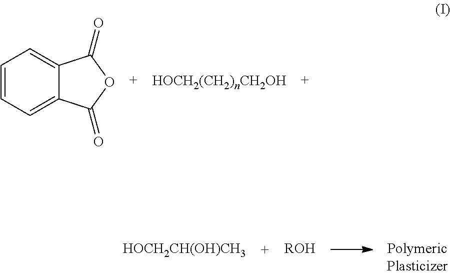 [SMILES: O=C1OC(=O)c2ccccc21 ; "HOCH2CH(OH)CH3" ; "ROH"]

n ranges from 0 to 8. R is selected from the group consisting of saturated, linear or branched alkyl having 1 to 10 carbon atoms. The number average molecular weight of the polymeric plasticizer ranges from 400 to 3,000 and wherein the plastisol comprises 10 weight percent to 70 weight percent of the polymeric plasticizer, 10 weight percent to 70 weight percent of the polymeric component, and 10 weight percent to 80 weight percent of other components, each based on the total weight of the plastisol, and wherein the other components comprise a second plasticizer, fillers, pigments, stabilizers, foaming agents, hollow materials, elastomeric materials, rheology control additives, and/or adhesion promoters; or 15 weight percent to 60 weight percent of the polymeric plasticizer, 15 weight percent to 60 weight percent of the polymeric component, and 10 weight percent to 60 weight percent of other components; or 20 weight percent to 45 weight percent of the polymeric plasticizer, 20 weight percent to 45 weight percent of the polymeric component, and 10 weight percent to 50 weight percent of other components.

A2. The plastisol according to embodiment A1, wherein n is 2 and R is 2-ethylhexyl.

A3. The plastisol according to any of embodiments A1-A2, wherein the number average molecular weight of the polymeric plasticizer ranges from 400 to 2000 or from 600 to 1,800.

A4. The plastisol according to any of embodiments A1-A3, wherein the polymeric component comprises polyvinyl chloride, polyvinyl acetate, acrylic polymers, and/or vinyl chloride-containing copolymers; or wherein the polymeric component comprises polyvinyl chloride.

A5. The plastisol according to embodiment A4, wherein the polymeric component comprises the polyvinyl chloride and the acrylic polymer; the polyvinyl chloride and the polyvinyl acetate; the polyvinyl chloride and the vinyl chloride-containing copolymers comprising acetate; or the polyvinyl chloride and the vinyl chloride-containing copolymers comprising acrylic.

A6. The plastisol according to any of embodiments A1-A5, wherein the plastisol has a viscosity ranging from 5,000 to 200,000 cP using Brookfield viscosity measurement at 23° C.; wherein the plastisol has a viscosity ranging from 30,000 to 120,000 cP; or wherein the plastisol has a viscosity ranging from 40,000 to 90,000 cP.

A7. The plastisol according to any of embodiments A1-A6, wherein the second plasticizer comprises phthalates; terephthalates; isophthalates; trimellitates; adipates; cyclohexanedicarboxylates; benzoates; phosphates; diesters of ethylene glycol, propylene glycol, their oligomers, and mixtures thereof; citrates; succinates; alkyl sulfonates; fatty acid esters and epoxidized fatty acid esters; triglycerides and epoxidized triglycerides, optionally substituted; dianhydrohexitol diesters; pentaerythritol-based tetraesters; furan-based esters; other esters; ketals; and/or other polymeric plasticizers; or wherein the second plasticizer comprises dioctyl terephthalate, diisooctyl phthalate, di-2-ethylhexyl phthalate, di-2-ethylhexyl terephthalate, tri-2-ethylhexyl trimellitate, di-2-propylheptyl phthalate, diisononyl phthalate, diisodecyl phthalate, diisoundecyl phthalate, ditridecyl phthalate, trioctyl trimellitate, triisononyl trimellitate, 2,2,4-trimethyl-1,3-pentanediol diisobutyrate, isononyl benzoate, isodecyl benzoate, diisononyl 1,2-cyclohexanedicarboxylate, dioctyl adipate, di-2-ethylhexyl adipate, triethylene glycol di-2-ethylhexanoate, diethylene glycol dibenzoate, dipropylene glycol dibenzoate, and/or dibenzoates produced from mixtures of diethylene glycol and dipropylene glycol.

A8. The plastisol according to any of embodiments A1-A7, wherein the fillers comprise calcium carbonate, magnesium carbonate, silica, clay, mica, graphite, zinc oxide, and/or calcium oxide; or the fillers comprise calcium carbonate.

A9. The plastisol according to any of embodiments A1-A8, wherein the stabilizers comprise metal soaps, epoxidized oils and epoxidized fatty acid esters, and/or organotin compounds.

A10. The plastisol according to any of embodiments A1-A9, wherein the foaming agents comprise azodicarbonamide.

A11. The plastisol according to any of embodiments A1-A10, wherein the hollow materials comprise inorganic or organic glass beads, microbeads, and/or microspheres.

A12. The plastisol according to any of embodiments A1-A11, wherein the elastomeric materials comprise nitrile-butadiene rubber, natural rubber, isoprene rubber, butadiene rubber, styrene-butadiene rubber, butyl rubber, ethylene-propylene-diene monomer (EPDM) rubber, chloroprene rubber, styrenated block copolymers, ethylene-vinyl acetate copolymers, olefinic elastomers, olefinic copolymer elastomers, silicone elastomers, polysulfide elastomers, and/or polyurethane elastomers.

A13. The plastisol according to any of embodiments A1-A12, wherein the rheology control additives comprise petroleum distillates; mineral oil and/or mineral spirits; fatty acid esters; polyphenyl oligomers; and/or organic solvents.

BA14. The plastisol according to any of embodiments A1-A13, wherein the adhesion promoters comprise polyamidoamines, blocked isocyanates and isocyanurates, silanes, and/or epoxy resins.

A15. The plastisol according to any of embodiments A1-A14, wherein the fused plastisol has a maximum Tan Delta (Tan δₘₐₓ) occurring between 10° C. and 50° C. and has Tan Delta at 30° C. (Tan δ_{30C}) ranging from 0.5 to 2.0, when measured on a sample nominally 0.6-0.7 mm thick, 3.2 mm wide, and 10-12 mm long using a Dynamic Mechanical Analyzer with a Tension Clamp at a strain of 0.1% and at a frequency of 1 Hz and a temperature ramp rate of 3° C./min.

A16. The plastisol according to embodiment A15, wherein the Tan Delta at 30° C. (Tan δ_{30C}) ranges from 0.5 to 1.8 or 0.5 to 1.6 or 0.5 to 1.4 or 0.6 to 2.0 or 0.6 to 1.8 or 0.6 to 1.6 or 0.6 to 1.4 or 0.7 to 2.0 or 0.7 to 1.8 or 0.7 to 1.6 or 0.7 to 1.4.

A17. The plastisol according to any of embodiments A1-A16, wherein a Tan Delta at 20° C. (Tan δ_{20C}) ranges from 0.5 to 1.8 or 0.5 to 1.6 or 0.5 to 1.4 or 0.6 to 2.0 or 0.6 to 1.8 or 0.6 to 1.6 or 0.6 to 1.4 or 0.7 to 2.0 or 0.7 to 1.8 or 0.7 to 1.6 or 0.7 to 1.4.

A18. The plastisol according to any of embodiments A15-A17, wherein the maximum Tan Delta (Tan δₘₐₓ) occurs between 10° C. and 40° C. or 20° C. and 50° C.

B1. A method of improving vibration damping of a substrate comprising affixing a plastisol according to any of claims A1-A18 onto a substrate.

B2. The method according to embodiment B1, wherein the affixing comprises (a) applying the plastisol onto the substrate; (b) fusing the plastisol to produce a plastisol-covered substrate; and (c) cooling the plastisol-covered substrate to ambient temperatures.

B3. The method according to embodiments B2, wherein the applying the plastisol onto the substrate comprises coating the substrate with the plastisol.

B4. The method according to embodiment B3, wherein the coating comprises spray coating and/or extrusion coating.

B5. The method according to embodiments B1, wherein the affixing comprises (a) fusing the plastisol into a sheet; and (b) adhering the sheet to the substrate.

B6. The method according to any of embodiments B2-B5, wherein the fusing occurs at a temperature ranging from 100° C. to 220° C. for a time period ranging from 1 min to 2 hours; or at a temperature ranging from 140° C. to 180° C. for a time period ranging from 15 min. to 40 min.

B7. The method according to any of embodiments B1-B6, wherein the substrate is part of a wheeled vehicle.

B8. The method according to embodiment B7, wherein the substrate is on the underbody of the wheeled vehicle

### EXAMPLES

The following compounds are commercially available and were used without further processing; Admex™ 523 Plasticizer (Example 1), Eastman 168™ Non-Phthalate Plasticizer (Comparative Example 1), Benzoflex™ 9-88 Plasticizer (Comparative Example 2), Benzoflex™ 131 Plasticizer (Comparative Example 3), and Admex™ 6995 (Comparative Example 4) (Eastman Chemical Company, Kingsport, Tenn.); and Santicizer™ 278 Plasticizer (Comparative Example 5, Ferro Corporation, Mayfield, Ohio). All other ingredients used in the plastisols hereafter described are commercially available and were used without further processing.

### Preparation of PVC Formulations and Samples for DMTA Evaluation

### Example 2

A FlackTek SpeedMixer™ model 150FV was used to prepare PVC plastisols. To a mixing cup was added 7 grams Geon™ 121A PVC paste resin, 3 grams Geon™ 217 PVC blending resin, 4 grams UltraPflex™ precipitated calcium carbonate, 8 grams Hubercarb™ Q325 calcium carbonate, 0.4 grams calcium oxide, 0.2 grams zinc oxide, optionally Varsol™ 18 Non-dearomatized Fluid, and 15 grams Admex™ 523 Plasticizer. The contents were shaken in the mixer for 45 seconds and the side of the container was scraped. This process was repeated twice to ensure complete dispersion. The resulting plastisol was then deaerated in a dessicator to which vacuum was applied for 20 minutes.

Samples for DMTA analysis were prepared by drawdowns of the deaerated plastisols onto release paper at a 25 mil thickness, then fused at 350° F. for 25 minutes. Dynamic Mechanical Thermal Analysis (DMTA) measurements were performed on these samples using a tension clamp on a DMA Q800 from TA Instruments. Samples were cut using a ⅛ inch precision cutter, and sample width and thickness were recorded into the software. After loading the sample into the tension clamps, the software measured and recorded sample length. A 0.1% strain was placed on the sample at a 1 Hz frequency. The sample was then cooled with liquid nitrogen to −100° C. Once the temperature equilibrated, the sample was heated at a 3° C. per minute rate until a maximum of 100° C. maximum was reached. Storage modulus, loss modulus, and tan δ results were recorded.

### Example 3-Example 8

Example 2 was repeated, using the type and amount of plasticizer as indicated in Table 1a. The correspondent tan δ results are given in Table 1b.

TABLE 1a
Plastisols: 7 parts Geon ™ 121A, 3 parts Geon ™ 217, 4 parts
UltraPflex ™, 8 parts Q325, 0.4 parts calcium oxide, 0.2 parts zinc oxide,
plasticizers and optionally Varsol ™ 18 rheology control additive as noted

| Example | Plasticizer Example | Parts Plasticizer | Parts Varsol |
|---|---|---|---|
| 2 | 1 | 15 | 0 |
| 3(a) | 1 | 15 | 1 |
| 4 | Comparative Example 1 | 15 | 0 |
| 5 | Comparative Example 2 | 15 | 0 |
| 6 | Comparative Example 3 | 12 | 0 |
| 7(a) | Comparative Example 3 | 10 | 0 |
| 8(a) | Comparative Example 5 | 15 | 0 |

TABLE 1b
Tan Delta

| | Plasticizer | Tan Delta (Tan δ) at given temperature (° C.) | | | | | | | | |
|---|---|---|---|---|---|---|---|---|---|---|
| Example | Example | −30 | −20 | −10 | 0 | 10 | 20 | 30 | 40 | 50 |
| 2 | 1 | 0.10 | 0.15 | 0.28 | 0.52 | 0.85 | 0.95 | 0.52 | 0.27 | 0.17 |
| 3(a) | 1 | 0.06 | 0.10 | 0.22 | 0.49 | 0.86 | 1.07 | 0.61 | 0.31 | 0.18 |
| 4 | Comparative | 0.59 | 0.82 | 0.56 | 0.33 | 0.21 | 0.14 | 0.11 | 0.09 | 0.08 |
| | Example 1 | | | | | | | | | |
| 5 | Comparative | 0.07 | 0.21 | 0.44 | 0.70 | 0.85 | 0.53 | 0.28 | 0.17 | 0.13 |
| | Example 2 | | | | | | | | | |
| 6 | Comparative | 0.17 | 0.19 | 0.22 | 0.25 | 0.29 | 0.32 | 0.32 | 0.29 | 0.26 |
| | Example 3 | | | | | | | | | |
| 7(a) | Comparative | 0.18 | 0.20 | 0.22 | 0.24 | 0.27 | 0.29 | 0.29 | 0.26 | 0.24 |
| | Example 3 | | | | | | | | | |
| 8(a) | Comparative | 0.09 | 0.12 | 0.25 | 0.58 | 1.02 | 0.89 | 0.46 | 0.25 | 0.16 |
| | Example 5 | | | | | | | | | |

For a limited number of the plastisols listed in Table 1a, the plastisol formulation was made a second time with the addition of 0.6 parts of Nourybond 272 (an adhesive promoter). These plastisols were subject to the Oberst bar method test.

The test was conducted as follows. Measurements were in accordance with the test method described in the SAE Recommended Practice J 1637-07, Laboratory Measurement of Composite Vibration Damping Properties of Materials on a Supporting Steel Bar.

The nominal dimensions of the steel bars were: mounted free length 200 mm, thickness 0.8 mm, and width 12.7 mm. Visco-elastic (damping) materials were bonded to this bar. Any excess material bonded to the bar was removed and cleaned, prior to installing the bar on the test set-up. The test temperatures that were used for this study were 10° C., 25° C., and 40° C.

Tests were made on a fixture to measure various modes of vibration that were generally between 100 Hz and 1000 Hz for each test bar using a random noise signal. The resonant frequency and the half power bandwidth (frequency difference between 3 dB down points from the resonant peak) of each mode needed for composite loss factor computation were read directly from a Pulse Multi-Analyzer System Type 3560. When the 3 dB down points on both sides of the resonant frequency were not measurable, the “n” dB down point method was used wherever possible per SAE Standard J1637-07.

The Oberst bar composite loss factors are shown as interpolated values at 200 Hz, 400 Hz, and 800 Hz for each temperature. These values are based on linear interpolation of two sets of data points where the frequency and the loss factor information are provided in a logarithmic scale. Should it not have been possible to interpolate data, then it was extrapolated. Results are shown in Table 2.

TABLE 2
Oberst bar composite loss factors

| Plastisol | | | 3(b) | 7(b) | 8(b) |
|---|---|---|---|---|---|
| Oberst bar test | Coating thickness, mm | | 2.4 | 2.0 | 2.1 |
| results | 10° C. | 200 Hz | 0.129 | 0.033 | 0.098 |
| | | 400 Hz | 0.157 | 0.036 | 0.132 |
| | | 800 Hz | 0.203 | 0.039 | 0.189 |
| | 25° C. | 200 Hz | 0.029 | 0.022 | 0.022 |
| | | 400 Hz | 0.042 | 0.026 | 0.032 |
| | | 800 Hz | 0.056 | 0.026 | 0.039 |
| | 40° C. | 200 Hz | 0.008 | 0.012 | 0.006 |
| | | 400 Hz | 0.009 | 0.013 | 0.008 |
| | | 800 Hz | 0.012 | 0.015 | 0.009 |

### Example 9

A FlackTek SpeedMixer™ model 150FV was used to prepare PVC plastisols. To a mixing cup was added 10 grams Geon™ 121A PVC paste resin, 4 grams Geon™ 217 PVC blending resin, 6 grams UltraPflex™ precipitated calcium carbonate, 0.4 grams calcium oxide, 0.2 grams zinc oxide, 2.5 grams Varsol 18™ Non-dearomatized Fluid, and 13 grams of Admex™ 523 Plasticizer (Example 1). The contents were shaken in the mixer for 45 seconds and the side of the container was scraped. This process was repeated twice to ensure complete dispersion. The resulting plastisol was then deaerated in a desiccator to which vacuum was applied for 20 minutes Tan δ results at temperatures from −30° C. to 50° C., in 10° C. increments, are given in Table 3b.

### Example 10-Example 20

Example 9 was repeated, using the type and amount of plasticizer and the amount of Varsol rheology control additive as indicated in Table 3a. The correspondent tan δ results are given in Table 3b.

TABLE 3a
Plastisols: 10 parts Geon ™ 121A, 4 parts Geon ™ 217, 6 parts
UltraPflex ™, 0.4 parts calcium oxide, 0.2 parts zinc oxide, plasticizers
and Varsol ™ 18 rheology control additive as noted

| Example | Plasticizer Example | Parts Plasticizer | Parts Varsol |
|---|---|---|---|
| 9 | 1 | 13 | 2.5 |
| 10(a) | 1 | 12 | 2.5 |
| 11 | 1 | 10 | 2.5 |
| 12 | 1 | 9 | 3 |
| 13 | Comparative Example 1 | 10 | 1 |
| 14 | Comparative Example 1 | 8 | 2 |
| 15(a) | Comparative Example 1 | 6 | 3 |
| 16(a) | Comparative Example 2 | 10 | 2 |
| 17(a) | Comparative Example 3 | 9 | 0 |
| 18(a) | Comparative Example 4 | 12 | 2.5 |
| 19(a) | Comparative Example 5 | 10 | 2 |
| 20(a) | Comparative Example 5 | 8 | 2.5 |

TABLE 3b
Tan Delta

| | Plasticizer | Tan Delta (Tan δ) at given temperature (° C.) | | | | | | | | |
|---|---|---|---|---|---|---|---|---|---|---|
| Example | Example | −30 | −20 | −10 | 0 | 10 | 20 | 30 | 40 | 50 |
| 9 | 1 | 0.04 | 0.06 | 0.10 | 0.20 | 0.38 | 0.61 | 0.82 | 0.57 | 0.29 |
| 10(a) | 1 | 0.06 | 0.08 | 0.13 | 0.22 | 0.38 | 0.57 | 0.74 | 0.55 | 0.28 |
| 11 | 1 | 0.05 | 0.06 | 0.07 | 0.11 | 0.17 | 0.30 | 0.50 | 0.71 | 0.54 |
| 12 | 1 | 0.04 | 0.05 | 0.07 | 0.12 | 0.20 | 0.34 | 0.53 | 0.74 | 0.55 |
| 13 | Comparative | 0.16 | 0.21 | 0.26 | 0.31 | 0.37 | 0.40 | 0.36 | 0.27 | 0.19 |
| | Example 1 | | | | | | | | | |
| 14 | Comparative | 0.12 | 0.15 | 0.18 | 0.22 | 0.26 | 0.32 | 0.37 | 0.36 | 0.29 |
| | Example 1 | | | | | | | | | |
| 15(a) | Comparative | 0.07 | 0.09 | 0.11 | 0.14 | 0.18 | 0.23 | 0.29 | 0.36 | 0.39 |
| | Example 1 | | | | | | | | | |
| 16(a) | Comparative | 0.03 | 0.05 | 0.10 | 0.19 | 0.31 | 0.45 | 0.61 | 0.55 | 0.29 |
| | Example 2 | | | | | | | | | |
| 17(a) | Comparative | 0.11 | 0.13 | 0.14 | 0.16 | 0.18 | 0.20 | 0.21 | 0.19 | 0.17 |
| | Example 3 | | | | | | | | | |
| 18(a) | Comparative | 0.08 | 0.16 | 0.28 | 0.41 | 0.53 | 0.52 | 0.36 | 0.23 | 0.15 |
| | Example 4 | | | | | | | | | |
| 19(a) | Comparative | 0.04 | 0.05 | 0.08 | 0.14 | 0.25 | 0.45 | 0.70 | 0.74 | 0.41 |
| | Example 5 | | | | | | | | | |
| 20(a) | Comparative | 0.04 | 0.05 | 0.06 | 0.09 | 0.15 | 0.27 | 0.49 | 0.74 | 0.59 |
| | Example 5 | | | | | | | | | |

For a limited number of the plastisols listed in Table 3a, the plastisol formulation was made a second time with the addition of 0.6 parts of Nourybond 272 (an adhesive promoter). These plastisols were subject to the Oberst bar method test as described previously. Results are shown in Table 4.

TABLE 4
Oberst bar composite loss factors

| | | | Plastisol | | | | | | |
|---|---|---|---|---|---|---|---|---|---|
| | | | 10(b) | 15(b) | 16(b) | 17(b) | 18(b) | 19(b) | 20(b) |
| Oberst bar test results | Coating thickness, mm | | 2.3 | 2.2 | 2.3 | 2.0 | 2.5 | 2.5 | 1.8 |
| | 10° C. | 200 Hz | 0.086 | 0.045 | 0.085 | 0.040 | 0.047 | 0.119 | 0.068 |
| | | 400 Hz | 0.096 | 0.051 | 0.093 | 0.046 | 0.058 | 0.130 | 0.073 |
| | | 800 Hz | 0.129 | 0.056 | 0.117 | 0.044 | 0.070 | 0.155 | 0.089 |
| | 25° C. | 200 Hz | 0.037 | 0.040 | 0.036 | 0.026 | 0.014 | 0.069 | 0.047 |
| | | 400 Hz | 0.046 | 0.044 | 0.045 | 0.030 | 0.019 | 0.081 | 0.051 |
| | | 800 Hz | 0.059 | 0.051 | 0.058 | 0.034 | 0.023 | 0.115 | 0.073 |
| | 40° C. | 200 Hz | 0.011 | 0.030 | 0.012 | 0.013 | 0.005 | 0.017 | 0.019 |
| | | 400 Hz | 0.013 | 0.035 | 0.015 | 0.015 | 0.007 | 0.021 | 0.020 |
| | | 800 Hz | 0.018 | 0.039 | 0.020 | 0.018 | 0.008 | 0.031 | 0.028 |

Other embodiments will be apparent to those skilled in the art from consideration of the specification and practice of the embodiments disclosed herein. It will be understood that variations and modifications can be effected within the spirit and scope of the disclosed embodiments. It is further intended that the specification and examples be considered as exemplary only, with a true scope and spirit of the disclosed embodiments being indicated by the following.

We claim:

1. A plastisol comprising a polymeric component and a polymeric plasticizer wherein said polymeric plasticizer is produced by reaction (I) 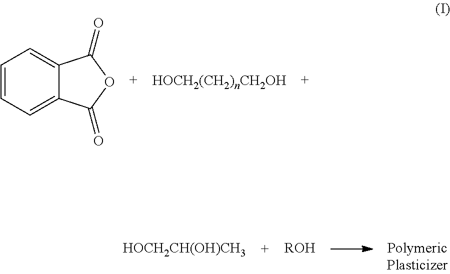 [SMILES: O=C1OC(=O)c2ccccc21 ; "HOCH2CH(OH)CH3" ; "ROH"]
wherein n ranges from 0 to 8; R is selected from the group consisting of saturated, linear or branched alkyl having 1 to 10 carbon atoms; and the number average molecular weight of said polymeric plasticizer ranges from 400 to 3000, and wherein said plastisol comprises 10 weight percent to 70 weight percent of said polymeric plasticizer, 10 weight percent to 70 weight percent of said polymeric component, and 10 weight percent to 80 weight percent of other components, each based on the total weight of said plastisol, and wherein said other components comprise a second plasticizer, fillers, pigments, stabilizers, foaming agents, hollow materials, elastomeric materials, rheology control additives, and/or adhesion promoters.

2. The plastisol according to claim 1, wherein n is 2 and R is 2-ethylhexyl.

3. The plastisol according to claim 1, wherein said number average molecular weight of said polymeric plasticizer ranges from 400 to 2000.

4. The plastisol according to claim 1, wherein said polymeric component comprises polyvinyl chloride, polyvinyl acetate, acrylic polymers, and/or vinyl chloride-containing copolymers.

5. The plastisol according to claim 1, wherein said plastisol has a viscosity ranging from 5,000 to 200,000 cP using Brookfield viscosity measurement at 23° C.

6. The plastisol according to claim 1, wherein said second plasticizer comprises phthalates; terephthalates; isophthalates; trimellitates; adipates; cyclohexanedicarboxylates; benzoates; phosphates; diesters of ethylene glycol, propylene glycol, their oligomers, and mixtures thereof; citrates; succinates; alkyl sulfonates; fatty acid esters and epoxidized fatty acid esters; triglycerides and epoxidized triglycerides, optionally substituted; dianhydrohexitol diesters; pentaerythritol-based tetraesters; furan-based esters; other esters; ketals; and/or other polymeric plasticizers.

7. The plastisol according to claim 1, wherein said second plasticizer comprises dioctyl terephthalate, diisooctyl phthalate, di-2-ethylhexyl phthalate, di-2-ethylhexyl terephthalate, tri-2-ethylhexyl trimellitate, di-2-propylheptyl phthalate, diisononyl phthalate, diisodecyl phthalate, diisoundecyl phthalate, ditridecyl phthalate, trioctyl trimellitate, triisononyl trimellitate, 2,2,4-trimethyl-1,3-pentanediol diisobutyrate, isononyl benzoate, isodecyl benzoate, diisononyl 1,2-cyclohexanedicarboxylate, dioctyl adipate, di-2-ethylhexyl adipate, triethylene glycol di-2-ethylhexanoate, diethylene glycol dibenzoate, dipropylene glycol dibenzoate, and/or dibenzoates produced from mixtures of diethylene glycol and dipropylene glycol.

8. The plastisol according to claim 1, wherein said fillers comprise calcium carbonate, magnesium carbonate, silica, clay, mica, graphite, zinc oxide, and/or calcium oxide.

9. The plastisol according to claim 1, wherein said rheology control additives comprise petroleum distillates; mineral oil and mineral spirits; fatty acid esters; polyphenyl oligomers; and/or organic solvents.

10. The plastisol according to claim 1, wherein said fused plastisol has a maximum Tan Delta (Tan δₘₐₓ) occurring between 10° C. and 50° C. and has Tan Delta at 30° C. (Tan δ_{30C}) ranging from 0.5 to 2.0, when measured on a sample nominally 0.6-0.7 mm thick, 3.2 mm wide, and 10-12 mm long using a Dynamic Mechanical Analyzer with a Tension Clamp at a strain of 0.1% and at a frequency of 1 Hz and a temperature ramp rate of 3° C./min.

11. The plastisol according to claim 1, wherein a Tan Delta at 20° C. (Tan δ_{20C}) ranges from 0.5 to 1.8.

12. The plastisol according to claim 10, wherein said maximum Tan Delta (Tan δₘₐₓ) occurs between 10° C. and 40° C.

13. A method of improving vibration damping of a substrate comprising affixing a plastisol onto said substrate, wherein said plastisol comprises a polymeric component and a polymeric plasticizer wherein said polymeric plasticizer is produced by reaction (I) 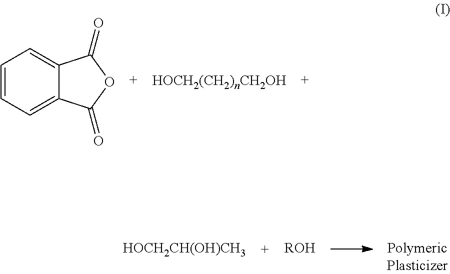 [SMILES: O=C1OC(=O)c2ccccc21 ; "HOCH2CH(OH)CH3" ; "ROH"]
wherein n ranges from 0 to 8; R is selected from the group consisting of saturated, linear or branched alkyl having 1 to 10 carbon atoms; and the number average molecular weight of said polymeric plasticizer ranges from 400 to 3000.

14. The method according to claim 13, wherein said affixing comprises
a. applying said plastisol onto said substrate;
b. fusing said plastisol to produce a plastisol-covered substrate; and
c. cooling said plastisol-covered substrate to ambient temperatures.

15. The method according to claim 14, wherein said applying said plastisol onto said substrate comprises coating said substrate with said plastisol.

16. The method according to claim 15, wherein said coating comprises spray coating and/or extrusion coating.

17. The method according to claim 16, wherein said affixing comprises
a. fusing said plastisol into a sheet; and
b. adhering said sheet to said substrate.

18. The method according to claim 14, wherein said fusing occurs at a temperature ranging from 100° C. to 220° C. for a time period ranging from 1 min to 2 hours.

19. The method according to claim 17, wherein said fusing occurs at a temperature ranging from 100° C. to 220° C. for a time period ranging from 1 min to 2 hours.

20. The method according to claim 13, wherein said substrate is part of a wheeled vehicle.
